(19) United States
(12) Patent Application Publication
(10) Pub. No.: US 2026/0120706 A1
(43) Pub. Date: Apr. 30, 2026

(54) Voice Data Processing for Hearing Aid

(71) Applicant: Anker Innovations Technology Co., Ltd., Changsha (CN)

(72) Inventors: Rui Zhu, Shenzhen (CN); Jianqiang Wei, Shenzhen (CN)

(21) Appl. No.: 19/363,316

(22) Filed: Oct. 20, 2025

(30) Foreign Application Priority Data
Oct. 24, 2024 (CN) 202411497312.8

(51) Int. Cl. G10L 21/0272; H04R 25/00

(52) U.S. Cl. CPC G10L 21/0272; H04R 25/453; H04R 25/505

(57) ABSTRACT

The present application describes a method for processing voice data for a binaural hearing aid. The binaural hearing aid may comprise a first hearing aid and a second hearing aid. The method may comprise acquiring voice data collected by the first hearing aid and the second hearing aid respectively; and extracting a voiceprint feature from the voice data based on determining that potential self-talk voice is in the voice data. The method may further comprise determining, based on voice sample data of a user, standard voiceprint feature associated with the user. In addition, the method may further comprise comparing the voiceprint feature with the standard voiceprint feature to obtain a comparison result; and enhancing the voice data based on determining that the comparison result indicates self-talk voice in the voice data.

### CROSS-REFERENCE TO RELATED APPLICATION

The present application claims priority to CN application No. 202411497312.8, filed on Oct. 24, 2024. The above application is incorporated herein by its entirety.

### TECHNICAL FIELD

The present application relates to the technical field of audio processing, and in particular, to a method for processing voice data for a binaural hearing aid.

### BACKGROUND

Binaural hearing aids are a type of hearing assistance devices, aiming at improving the hearing effect by simultaneously using two hearing aids, and the two hearing aids may share information collected by microphones. Users often complain about the problems of excessive (self-talk) volume, ear occlusion, severe voice distortion, etc. when wearing hearing aids. Therefore, self-talk sound optimization solutions have been developed to reduce ear occlusion and improve self-talk experience. Self-talk sound optimization detects wearer's airborne sound, and then processes the sound through an algorithm to recognize whether the currently received sound is wearer's voice or external sound, thereby achieving “self-talk sound attenuation,” avoiding the common sensation of ear occlusion of hearing aids, achieving clear and comfortable hearing, and bringing users a more natural self-talk sound experience.

However, conventional self-talk sound recognition is usually based on spatial orientation clues of self-talk sound for detection, so self-talk determination errors are prone to occur.

### SUMMARY

In view of the above technical problems, it is desirable to provide a method for processing voice data with higher self-talk determination accuracy for a binaural hearing aid.

In a first aspect, the present application describes a method for processing voice data for a binaural hearing aid. The binaural hearing aid may comprise a first hearing aid and a second hearing aid. The method may comprise acquiring voice data collected by the first hearing aid and the second hearing aid respectively; and extracting a voiceprint feature from the voice data based on determining that potential self-talk voice is in the voice data. The method may further comprise determining, based on voice sample data of a user, standard voiceprint feature associated with the user. The voice sample data may comprise close-talk voice data collected by the first hearing aid that is closer to a mouth of the user than the second hearing aid. In addition, the method may further comprise comparing the voiceprint feature with the standard voiceprint feature to obtain a comparison result; and enhancing the voice data based on determining that the comparison result indicates self-talk voice in the voice data. In a second aspect, the present application provides a binaural hearing aid, including a first hearing aid, a second hearing aid, and one or more processors connected to the first hearing aid and the second hearing aid respectively. A first microphone array in the first hearing aid and a second microphone array in the second hearing aid may collect voice data and send the collected voice data to the processors, and the processors may perform the steps of the method for processing voice data in any of the above.

Different from conventional methods of self-talk detection based on spatial orientation clues of self-talk voice, in the method for processing voice data and the binaural hearing aid, close-talk voice data and voiceprint verification are introduced, where clearer close-talk voice data recorded by the user may be collected in advance through a first hearing aid close to the user's mouth. Standard voiceprint feature associated with the user can be extracted from the close-talk voice data, and the voiceprint feature can be stored. In subsequent practical applications, whether there is potential self-talk voice in the voice data can be determined in real time, where the voice data is collected by the first hearing aid and a second hearing aid. If it is determined that there is potential self-talk voice, the voiceprint verification is performed. For example, the voiceprint feature is extracted from the voice data, and the voiceprint feature is compared with the stored standard voiceprint feature to further accurately determine whether there is self-talk voice in the voice data. If it is determined that there is self-talk voice, the voice data is enhanced to reduce ear occlusion and sound distortion and improve user's auditory experience.

The solution does not rely on specific spatial orientation information for self-talk detection, but only needs to compare the voiceprint feature in the real-time collected voice data with the user's standard voiceprint feature. Since the user's standard voiceprint feature is extracted from the close-talk voice data including clear and definite user's voice characteristics, by comparing the voiceprint feature with the user's standard voiceprint feature, whether there is self-talk voice can be accurately detected, incorrect recognition caused by environmental noise or background sound is reduced, a relatively high recognition rate can be maintained even in noisy environments, and the robustness of a system is improved.

### BRIEF DESCRIPTION OF THE DRAWINGS

In order to illustrate technical solutions in the present application or the related art more clearly, the accompanying drawings required in the description of the present application or the related art will be briefly introduced below. The drawings described below show merely some examples of the present application. A person of ordinary skill in the art may also derive other related drawings based on these drawings without any creative efforts.

FIG. 1 is an application environment diagram of a method for processing voice data in an example;

FIG. 2 is a schematic flowchart of a method for processing voice data in an example;

FIG. 3 is a schematic flowchart of a self-talk voiceprint registration step in an example;

FIG. 4 is a schematic flowchart of a step of determining whether there is potential self-talk voice in voice data in an example;

FIG. 5 is a schematic flowchart of a step of determining whether there is potential self-talk voice in voice data in another example;

FIG. 6 is a schematic flowchart of a method for processing voice data in another example;

FIG. 7 is a structural block diagram of an apparatus for processing voice data in an example;

FIG. 8 is a structural block diagram of an apparatus for processing voice data in another example; and

FIG. 9 is an internal structural diagram of a computer device in an example.

### DETAILED DESCRIPTION

In order to make the objectives, technical solutions, and advantages of the present application clearer, the present application will be further described in detail below in conjunction with the accompanying drawings and examples. It should be understood that the specific examples described herein are merely used to explain the present application, but not to limit the present application.

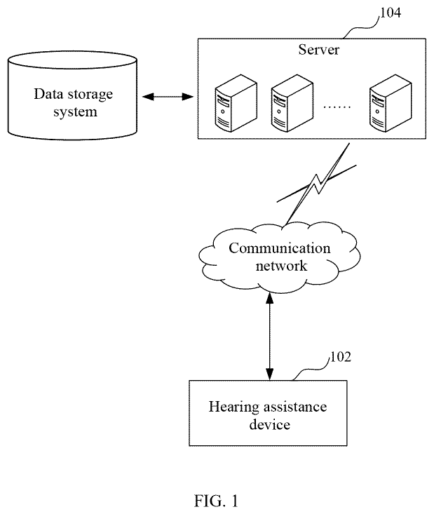

A method for processing voice data may be applied to an application environment shown in FIG. 1. A hearing assistance device 102, such as a binaural hearing aid including a first hearing aid and a second hearing aid, communicates with a server 104 through a network. A data storage system may store data. The server 104 needs to process the data, and the data includes a user's standard voiceprint feature. The standard voiceprint feature can be obtained by processing close-talk voice data, and the close-talk voice data can be collected by a microphone array. The microphone array may be located at or near the user's mouth. The data storage system may be integrated on the server 104, or placed on a cloud or another network server.

For example, the binaural hearing aid may acquire voice data collected by the first hearing aid and the second hearing aid respectively, and send the collected voice data to the server 104 in real time. The server 104 determines in real time whether there may be potential self-talk voice in the voice data. If it is determined that there is potential self-talk voice in the voice data, a voiceprint verification process can be performed to extract a voiceprint feature from the voice data. The extracted voiceprint feature can be compared with a stored user's standard voiceprint feature to obtain a comparison result. If the comparison result indicates that there is self-talk voice in the voice data, the voice data is enhanced, so that the user can hear his or her voice clearly.

It may be understood that the method may also be applied to hearing assistance devices such as a binaural hearing aid or other intelligent devices with computing capabilities, or applied to a system including a binaural hearing aid and a server and implemented through the interaction between the binaural hearing aid and the server.

The hearing assistance device 102 may include, but are not limited to, an earphone, a hearing aid, etc. The intelligent devices may include, but are not limited to, various personal computers, laptops, smart phones, tablets, Internet of things (IoT) devices, and portable wearable devices. The IoT devices may be smart speakers, smart televisions, smart air conditioners, smart vehicle devices, projection devices, etc. The portable wearable devices may be smart watches, smart wristbands, headset devices, etc. The headset devices may be virtual reality (VR) devices, augmented reality (AR) devices, smart glasses, etc. The server 104 may be an independent physical server, a server cluster or distributed system composed of a plurality of physical servers, or a cloud server providing cloud computing services.

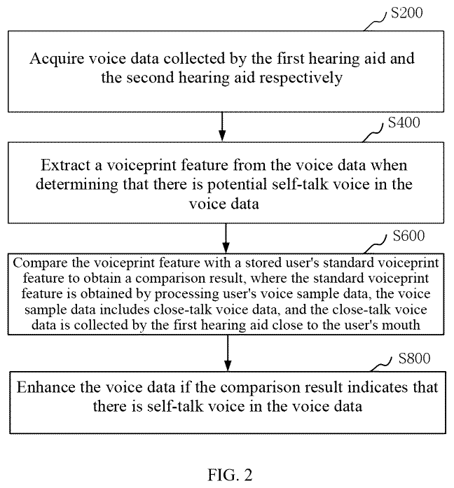

In an example, as shown in FIG. 2, a method for processing voice data is provided. The method is applied to the binaural hearing aid 102 in FIG. 1 as an example for explanation. In this example, the method includes steps S200 to S800.

S200: Acquire voice data collected by the first hearing aid and the second hearing aid respectively.

In this example, the first hearing aid and the second hearing aid are respectively worn on or near a user's ears, and may also be referred to as a left ear hearing aid and a right ear hearing aid. In practical applications, in a binaural hearing aid, microphone arrays in the left hearing aid and the right hearing aid may each include at least two microphones. The microphone arrays in the left hearing aid and the right hearing aid may continuously collect voice data. The voice data may include environmental noise and human voice signals, and the collected voice data may be sent to a processor or a control module of the binaural hearing aid. It may be understood that the voice data sent by the hearing aid to the server carries device identification information of the hearing aid, so that the server can determine which hearing aid sends the data.

S400: Extract a voiceprint feature from the voice data based on determining that there is potential self-talk voice in the voice data.

Self-talk voice refers to voice signals that are produced by a hearing aid wearer. The voice signals may be captured by a microphone or other audio collection devices and converted into electrical or digital signals. Potential self-talk voice data refers to user's self-talk voice that is not recognized (e.g., voice data that is produced by the hearing aid wearer and has not been analyzed or recognized among the voice data). The voiceprint feature refers to a unique acoustic feature in the sound produced by an individual, and these features may be used to recognize and distinguish different speakers. The formation of voiceprints is influenced by various factors, including the shape and size of the vocal cords, the structure of the oral and nasal cavities, pronunciation habits, etc.

Upon receiving the voice data sent by the first hearing aid and the second hearing aid, the processor determines in real time whether there is potential self-talk voice in the voice data (e.g., whether there may be self-talk voice). If it is determined that there is potential self-talk voice in the voice data, a voiceprint verification process will be performed. Specifically, the voice data may be pre-processed to separate a voice signal from the voice data and extract a voiceprint feature of the voice signal.

S600: Compare the voiceprint feature with a stored user's standard voiceprint feature to obtain a comparison result, where the standard voiceprint feature is obtained by processing user's voice sample data, the voice sample data includes close-talk voice data, and the close-talk voice data is collected by the first hearing aid close to the user's mouth.

In this example, the voice sample data includes voice data of a specified text, the specified text is recorded by the microphone array of the first hearing aid, and the first hearing aid is placed close to the user's mouth. Specifically, in the self-talk voiceprint registration process, the user takes down one of the hearing aids worn on the left and right ears (such as the first hearing aid worn on the right ear) and holds the hearing aid close to the mouth. At this time, the microphone array in the first hearing aid close to the mouth (e.g., the first microphone array) may be understood as a close-talk microphone array. The user records the voice data of the specified text through the close-talk microphone array and the second hearing aid to obtain the user's voice sample data, where the second hearing aid is still worn on the left ear. Subsequently, the voice sample data is pre-processed to separate pure self-talk voice of the user from the voice sample data. Next, a voiceprint feature is extracted from the self-talk voice, the extracted voiceprint feature is determined as the user's standard voiceprint feature, and the user's standard voiceprint feature is stored in a database. Specifically, the standard voiceprint feature may be associatively stored with device identification information of the hearing aid worn by the user or user identification in the database.

Following the previous step, after the voiceprint feature is extracted from the voice data, the user's standard voiceprint feature is acquired based on the device identification of the hearing aid or the user identification, and the user's standard voiceprint feature is compared with the extracted voiceprint feature to determine whether the user's standard voiceprint feature is consistent with the extracted voiceprint feature, so as to determine whether there is self-talk voice produced by the user in the voice data.

S800: Enhance the voice data if the comparison result indicates that the voice data includes self-talk voice.

The voice data is enhanced if the comparison result indicates that the voice data includes self-talk voice, so that the user can hear his or her voice more clearly. Specifically, the voice data may be enhanced based on preset enhancement parameters and user's personal preferences. For example, the user may adjust the volume, frequency response, or the like through a self-talk control on an application interface of a mobile terminal. In the fitting process, if the wearer feeds back that the self-talk voice sounds too low-frequency, a fitting technician may use a fitting tool to reduce the gain of the self-talk low frequency below 1000 hertz (Hz).

According to the foregoing method for processing voice data, clearer close-talk voice data recorded by the user is collected in advance through the first hearing aid close to the user's mouth, the user's standard voiceprint feature is extracted from the close-talk voice data, and the user's standard voiceprint feature is stored. In subsequent practical applications, whether there is potential self-talk voice in the voice data is determined in real time, where the voice data is collected by the first hearing aid and the second hearing aid. If it is determined that there is potential self-talk voice, voiceprint verification is performed, that is, the voiceprint feature is extracted from the voice data, and the voiceprint feature is compared with the stored user's standard voiceprint feature to further accurately determine whether there is self-talk voice in the voice data. If it is determined that there is self-talk voice, the voice data is enhanced to reduce ear occlusion and sound distortion and improve user's auditory experience. The entire solution does not rely on specific spatial orientation information for self-talk detection, but only needs to compare the voiceprint feature in the real-time collected voice data with the user's standard voiceprint feature. Since the user's standard voiceprint feature is extracted from the close-talk voice data including clear and definite user's voice characteristics, by comparing the voiceprint feature with the user's standard voiceprint feature, whether there is self-talk voice can be accurately detected, incorrect recognition caused by environmental noise or background sound is reduced, a relatively high recognition rate can be maintained even in noisy environments, and the robustness of a system is improved.

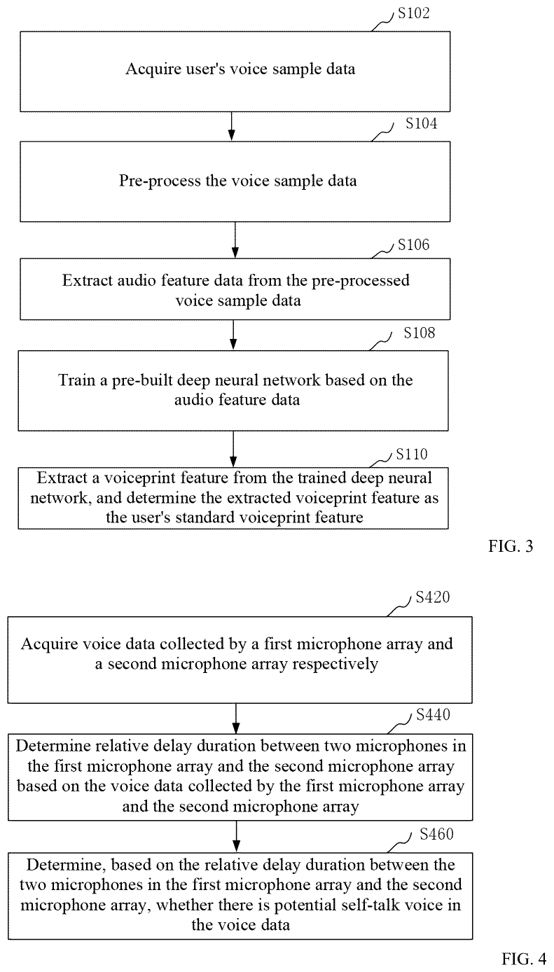

In practical applications, before the self-talk voice detection, user's self-talk voiceprints need to be registered for subsequent voiceprint verification to further determine whether there is self-talk voice. The self-talk voiceprint registration phase of the present application is different from a conventional method of recording user voice samples in a listening room by means of professional fitting technicians. The present application provides a more applicable self-talk voiceprint registration method. As shown in FIG. 3, in an example, before comparing the voiceprint feature with a stored user's standard voiceprint feature, the method further includes:

S102: Acquire user's voice sample data.

S104: Pre-process the voice sample data.

S106: Extract audio feature data from the pre-processed voice sample data.

S108: Train a pre-built deep neural network based on the audio feature data.

S110: Extract a voiceprint feature from the trained deep neural network, and determine the extracted voiceprint feature as the user's standard voiceprint feature.

In this example, the pre-built deep neural network may be a time delay neural network (TDNN). The time delay neural network is capable of processing information with time delays, making it very suitable for processing sequential data such as voice signals, where there are dependencies between data at different time points. It may be understood that in other examples, recurrent neural networks, long short-term memory networks, and other deep learning networks may also be used.

During specific implementation, the user may take down the first hearing aid worn on the right ear and hold the first hearing aid near the mouth. At this time, the microphone array in the first hearing aid near the mouth (e.g., the first microphone array) may be understood as a close-talk microphone array, and the microphone array in the second hearing aid worn on the left ear by the user is the second microphone array. The user records voice data of a specified text through the first microphone array and the second microphone array to obtain user's voice sample data. After obtaining the voice sample data, the processor pre-processes the voice sample data to separate user's pure self-talk voice from the voice sample data.

Specifically, the pre-processing may include, but is not limited to, framing, windowing, adaptive filtering, etc. After the pure self-talk voice is obtained through the pre-processing, a Mel frequency cepstral coefficients (MFCC) feature is extracted from the pure self-talk voice through an MFCC feature extraction method or other suitable feature extraction methods, and the extracted MFCC feature is normalized. Then, the normalized MFCC feature is input into the pre-built TDNN network. The TDNN network includes an input layer, a plurality of hidden layers, and an output layer. The neural network is trained through the voiceprint feature sample data to obtain a trained TDNN network. Next, the input MFCC feature may be propagated forward by using the trained TDNN network to extract a voiceprint feature such as an X-vector from the network layers of the network. The X-vector represents the speaker's voiceprint feature and is used to distinguish different speakers. Finally, the extracted X-vector is determined as a user's standard voiceprint feature. Further, the user's standard voiceprint feature may be associatively stored with the device identification of the hearing aid or the user identification in the database.

In this example, the deep neural network model is trained by extracting an audio feature from a voice sample, which can efficiently and accurately extract the user's voiceprint feature and is suitable for self-talk voice verification in different environments.

There are various ways to pre-process the voice sample data. In an exemplary example, pre-processing the voice sample data includes at least one of the following:
i. Frame the voice sample data.
ii. Window the voice sample data.
iii. Extract differential signals from output signals of the microphone arrays in the first hearing aid and the second hearing aid.
iv. Construct an adaptive blocking matrix based on the voice sample data, and filter input signals of the microphone arrays in the first hearing aid and the second hearing aid through the adaptive blocking matrix.
v. Cancel interference voice and noise signals from the output signals of the microphone arrays through a preset adaptive interference canceller.

In this example, in order to obtain purer self-talk voice, the voice sample data may be processed by at least one of the following methods: framing, windowing, extracting a differential microphone array (DMA), constructing an adaptive blocking matrix (ABM), and cancelling interference signals and noise signals through an adaptive interference canceller (AIC).

The framing involves segmenting continuous audio signals into small, overlapping frames for subsequent processing. Specifically, continuous audio signals may be segmented into small frames of a fixed length (such as 256 or 512 samples), with usually 50% overlap between the frames, to ensure signal continuity and reduce boundary effects.

The windowing process involves applying a window function to each frame to reduce spectrum leakage and boundary effects. Specifically, an appropriate window function (such as a Hanning window or a Hamming window) may be selected, and a sample of each frame is multiplied by a value of the window function.

The differential microphone array enhances desired signals and suppresses interference signals by calculating differential signals between a pair of microphones. Specifically, through a differential signal processing technology, differential signals are extracted from output signals of two microphones to enhance the directionality of desired signals.

The adaptive blocking matrix is used to generate a blocking signal, and the signal mainly includes interference voice and noise and seldom includes self-talk voice components. Specifically, the adaptive blocking matrix is constructed based on the voice sample data, and then coefficients of the adaptive blocking matrix are adjusted through an adaptive algorithm such as a least mean square (LMS) algorithm to filter the input signals of the microphone arrays and minimize the leakage of target voice signal.

The adaptive interference canceller is used to cancel interference voice and noise signals from the output signals of the microphone arrays through an adaptive filtering technology. Specifically, the blocking signal generated by the constructed blocking matrix is used as a reference signal, and filter coefficients are adjusted through an adaptive filter (such as an LMS filter), so that the filtered reference signal matches interference parts in the output signals of the microphone arrays as much as possible. The filtered reference signal is subtracted from the output signals of the microphone arrays, that is, the interference voice and noise signals are cancelled from the output signals of the microphone arrays, and an output mainly including desired signals is obtained.

In this example, through the foregoing pre-processing of the voice sample data, purer user's self-talk voice can be obtained, thereby providing a data basis for extracting more accurate voiceprint features subsequently.

In an exemplary example, the method further includes: acquiring voice activity detection information of the first microphone array of the first hearing aid, determining a signal-to-noise ratio of the voice data collected by the second microphone array of the second hearing aid, and updating parameters of the adaptive blocking matrix and the adaptive filter if the voice activity detection information indicates that a voice activity is detected out and the signal-to-noise ratio is higher than a preset signal-to-noise ratio threshold.

The voice activity detection information is a binary signal, where 1 indicates that the current frame includes a voice activity, and 0 indicates that the current frame does not include a voice activity. The signal-to-noise ratio is used to represent a ratio of signal strength to noise strength. The higher the signal-to-noise ratio, the higher the signal quality.

Following the previous example, in order to better separate speaker's voice from other interference and noise, the voice activity of the first microphone array may be detected through a voice activity detection (VAD) algorithm, to obtain voice activity detection information of the first microphone array (hereinafter referred to as VAD detection result). In addition, based on the voice signals collected by the second microphone array of the second hearing aid, the signal-to-noise ratio of the voice signals is calculated, where the second hearing aid is worn on the user's ear. Specifically, the signal-to-noise ratio may be determined as follows:
[\text{SNR}=10\log_{10}\left(\frac{P_{\text{signal}}}{P_{\text{noise}}}\right)]

Where (P_{\text{signal}}) represents signal power, (P_{\text{noise}}) represents noise power, and SNR represents a signal-to-noise ratio, usually in decibels (dB).

After the VAD detection result and the signal-to-noise ratio are obtained, it may be determined whether to update the parameters of the adaptive blocking matrix and the adaptive interference canceller based on the VAD detection result and the signal-to-noise ratio. Specifically, if the VAD detection result is 1 and the SNR of the second microphone array is higher than the preset signal-to-noise ratio threshold, such as 10 dB, the parameters of the adaptive blocking matrix and the adaptive interference canceller may be updated. Conversely, if the VAD detection result is 0 or the SNR of the second microphone array is lower than the preset signal-to-noise ratio threshold of 10 dB, the parameters of the adaptive blocking matrix and the adaptive interference canceller will not be updated. It may be understood that the signal-to-noise ratio threshold may be adjusted based on actual application scenarios to balance update frequency and performance.

In this example, the update time of the adaptive blocking matrix and the adaptive interference canceller is dynamically adjusted through the VAD detection result of the microphone of the first hearing aid and the signal-to-noise ratio of the voice data, where the first hearing aid is held by the user at the mouth, and the voice data is collected by the microphone array of the worn second hearing aid, to better separate self-talk voice from other interference and noise.

In practical applications, there are various ways of self-talk detection, including self-talk detection based on spatial orientation clues of self-talk voice, or self-talk detection through self-talk scanning. Due to a difference in time when microphones at different positions receive signals of a same sound source, the time difference is referred to as relative delay duration. Therefore, by measuring the relative delay duration, the position of the sound source may be estimated, and then whether the voice comes from a specific user may be determined.

As shown in FIG. 4, in an exemplary example, determining, based on the collected voice data, whether there is potential self-talk voice in the voice data, includes:

S420: Acquire voice data collected by a first microphone array and a second microphone array respectively.

S440: Determine relative delay duration between two microphones in the first microphone array and the second microphone array based on the voice data collected by the first microphone array and the second microphone array.

S460: Determine, based on the relative delay duration between the two microphones in the first microphone array and the second microphone array, whether there is potential self-talk voice in the voice data.

The relative delay duration between the microphones refers to a time difference when the microphones at different positions receive the signals of the same sound source. The time difference is mainly induced by different path lengths, where the path lengths are experienced by sound waves reaching the microphones at different positions. When the user produces self-talk voice, the voice reaches the two microphones almost simultaneously, so the relative delay duration is very short or close to zero. Therefore, in a multi-microphone system, by measuring the relative delay duration between different microphones, the direction and position of a sound source may be determined, and the angle of the human mouth relative to the microphone array may be estimated, thereby determining whether the signals received by the microphone are from the user's self-talk voice.

During specific implementation, voice data collected by the first microphone array in the first hearing aid and the second microphone array in the second hearing aid may be acquired, and the relative delay duration between the two microphones in the first microphone array of the first hearing aid and the second microphone array of the second hearing aid is calculated, to detect whether there is potential self-talk voice in the voice data. Specifically, the time difference when different microphones receive signals of the same sound source, e.g., the relative delay duration, may be measured through a time difference-based estimation algorithm, and the position or direction of the sound source is inferred accordingly. Alternatively, the relative delay duration may be determined through a frequency-based estimation method, such as a phase difference between the signals of the two microphones in the first microphone array and the second microphone array is calculated, and the phase difference is converted into a time difference, to obtain the relative delay duration between the two microphones in the first microphone array and the second microphone array. In other examples, the relative delay duration between the two microphones in the first microphone array and the second microphone array may also be directly estimated through a cross-correlation function.

In this example, the relative delay duration between the two microphones in the first microphone array and the second microphone array of the binaural hearing aid may be determined through the cross-correlation function. Subsequently, based on the relative delay duration between the two microphones in the first microphone array and the second microphone array, the angle of the human mouth relative to the microphone array is estimated to determine whether the sound source is from the user, and thus to determine whether there is potential self-talk voice in the voice data.

In this example, whether the voice data includes voice signals of a specific user is determined based on the relative delay duration between the two microphones in the first microphone array and the second microphone array, thereby improving the accuracy and robustness of voice recognition in complex environments.

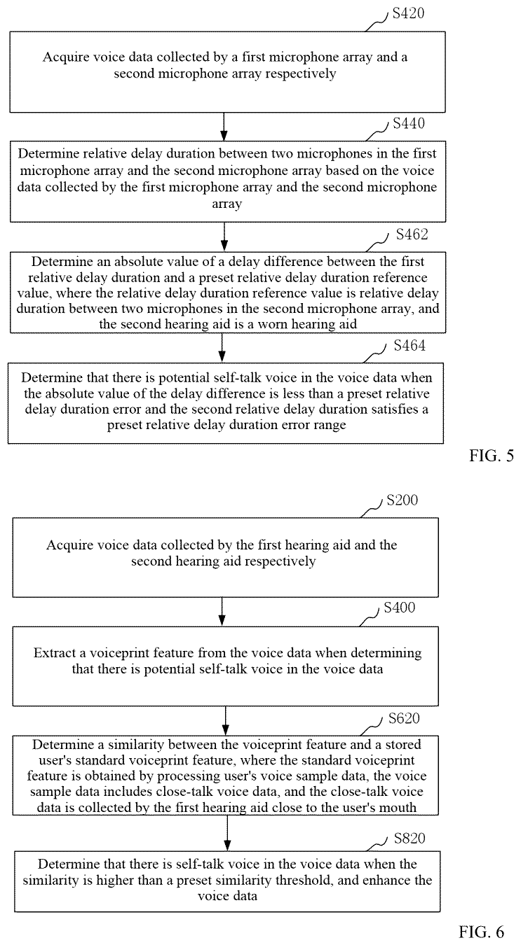

In an exemplary example, the relative delay duration between the two microphones in the first microphone array and the second microphone array includes first relative delay duration between two microphones in the same microphone array and second relative delay duration between two microphones in different microphone arrays. As shown in FIG. 5, S460 includes:

S462: Determine an absolute value of a delay difference between the first relative delay duration and a preset relative delay duration reference value, where the relative delay duration reference value is relative delay duration between two microphones in the second microphone array, and the second hearing aid is a worn hearing aid.

S464: Determine that there is potential self-talk voice in the voice data when the absolute value of the delay difference is less than a preset relative delay duration error and the second relative delay duration satisfies a preset relative delay duration error range.

In this example, the first relative delay duration between two microphones in the same microphone array includes relative delay duration between two microphones in the same microphone array of the first hearing aid, and relative delay duration between two microphones in the same microphone array of the second hearing aid. The second relative delay duration between two microphone arrays in different microphone arrays includes relative delay duration between a microphone in the first microphone array and a microphone in the second microphone array. It may be understood that, in this example, in order to distinguish the relative delay duration between different microphones in the left and right ear microphone arrays, the “first relative delay duration” and the “second relative delay duration” are used for distinguishing, essentially referring to the relative delay duration between microphones.

For example, each microphone array may include 2 microphones, the microphones in the microphone array of the hearing aid worn on the left ear are micL1 and micL2, and the microphones in the microphone array of the hearing aid worn on the right ear are micR1 and micR2. Through a generalized cross-correlation (GCC) method, the relative delay duration between micL1 and micL2 (i.e., the first relative delay duration) is determined, denoted as delayL. The relative delay duration between micR1 and micR2 (i.e., the first relative delay duration) is determined, denoted as delayR. The relative delay duration between micL1 and micR1 (i.e., the second relative delay duration) is determined, denoted as delay1. The relative delay duration between micL2 and micR2 (e.g., the second relative delay duration) is determined, denoted as delay2.

In practical applications, when the detected relative delay duration is close to zero or within a very small range, there may be user's self-talk voice. Conversely, when the relative delay duration is relatively long, the sound source is located on one side of or behind the microphone array, and is usually someone else's voice. Therefore, an allowable relative delay duration error may be preset based on relevant experience and experimental results, denoted as relative delay duration error D. In addition, the relative delay duration reference value between the microphones in the second microphone array of the hearing aid worn on the ear is determined to estimate the angle of the human mouth relative to the second microphone array. It may be understood that if one of the binaural hearing aid includes two or more microphone arrays, relative delay duration between every two microphones in the microphone arrays of the first hearing aid and the microphone arrays of the second hearing aid may be calculated, and whether the voice data includes potential self-talk voice is determined based on the relative delay duration between every two microphones.

In an example, the relative delay duration reference value may be obtained based on the following method: determining, by one or more processors, a relative impulse response of each microphone in the second hearing aid to the user's mouth; and obtaining the relative delay duration reference value based on the relative delay duration between the relative impulse responses.

The relative impulse response (RIR) is an impulse response of a system relative to a reference point or condition, and is usually used to compare impulse responses obtained at different positions, different time, or different conditions. Specifically, as the microphone array captures both direct sound from the speaker's mouth and ambient reflected sound, a relative transfer function of a direct sound path may be estimated through AIC processed signals. Specifically, relative impulse responses RIR1 and RIR2 of 2 microphones in the second hearing aid worn by the user to the human mouth may be estimated through a normalized least mean square (NLMS) coefficient in the adaptive interference cancellation method. Then, a maximum cross-correlation point (peak) between RIR1 and RIR2 is calculated through a cross-correlation function, where a delay corresponding to this point is relative delay duration between RIR1 and RIR2 (e.g., the relative delay duration reference value), denoted as delayRIR. Further, an angular position of the human mouth relative to the microphone array may be estimated by using a triangulation technology through the known geometric layout of the microphone array and the relative delay duration.

In addition, in the user's self-talk voiceprint registration process, after the user's voice sample data is acquired, the voice sample data may be pre-processed to separate pure self-talk voice. Based on the self-talk voice, correlation transfer functions RIR1 and RIR2 between 2 microphones in the left ear hearing aid worn on the user's left ear and the human mouth respectively are estimated through the NLMS coefficient in the adaptive interference cancellation method, and relative delay duration between the two transfer functions (i.e., the relative delay duration reference value) is calculated, denoted as delayRIR. Next, corresponding self-talk voice determination conditions are set based on the relative delay duration error D and the relative delay duration reference value delayRIR, for example, the absolute difference between the relative delay duration reference value and the relative delay duration between two microphones in the same microphone array needs to be less than a preset relative delay duration error, and the relative delay duration between two microphones in different microphone arrays needs to be within a preset relative delay duration error range.

In the subsequent self-talk voice detection process, whether there is self-talk voice in the voice data is determined through the self-talk voice determination conditions. Specifically, an absolute value of a delay difference between delayL and delayRIR and an absolute value of a delay difference between delayR and delayRIR may be first determined. Then, determination is performed based on the preset self-talk voice determination conditions. If the relative delay duration between microphones simultaneously satisfies the following self-talk voice determination conditions, it is determined that there is self-talk voice. The self-talk voice determination conditions are as follows:
1) delayL between micL1 and micL2, |delayL−delayRIR|<D
2) delayR between micR1 and micR2, |delayR−delayRIR|<D
3) delay1 between micL1 and micR1, −D<delay1<D
4) delay2 between micL2 and micR2, −D<delay2<D

If the relative delay duration between two microphones in different microphone arrays satisfy the above self-talk voice determination conditions, it is determined that there is potential self-talk voice in the voice data, and a voiceprint verification process will be performed. It may be understood that if one microphone array includes 2 or more microphones, the relative delay duration between two microphones in one microphone array and the relative delay duration between two microphones in different microphone arrays may also be calculated. For example, if the left and right ear microphone arrays each include 3 microphones, the microphones in the left ear microphone array are micL1, micL2, and micL3, and the microphones in the right ear microphone array are micR1, micR2, and micR3. Through the GCC method, relative delay durations between micL1 and micL2, micL1 and micL3, micL2 and micL3 (i.e., first relative delay durations) are determined, and relative delay durations between micR1 and micR2, micR1 and micR3, and micR2 and micR3 (i.e., first relative delay durations) are determined, respectively. In addition, relative delay durations between micL1 and micR1, micL2 and micR2, and micL3 and micR3 (i.e., second relative delay durations) are also determined.

In this example, by determining the relative delay duration error, the relative delay duration reference value, and the self-talk voice determination conditions, the potential self-talk voice can be quickly and accurately determined in practical applications.

For voiceprint verification, the voiceprints of the same speaker are verified by determining the degree of matching between a to-be-verified voiceprint feature and a standard voiceprint feature. In an exemplary example, as shown in FIG. 6, S600 includes S620: Determine a similarity between the voiceprint feature and the stored user's standard voiceprint feature.

S800 includes S820: Determine that there is self-talk voice in the voice data when the similarity is higher than a preset similarity threshold, and enhance the voice data.

In practical applications, one preset similarity threshold may be configured based on application requirements and experience. This threshold is used to determine whether the similarity between two voiceprint features is high enough to ensure recognition accuracy. In this example, the similarity threshold may be 90%. It may be understood that the similarity threshold may be adjusted according to an actual situation.

In this example, the similarity between the extracted X-vector and the user's X-vector may be determined by calculating a Euclidean distance between the two. If the similarity is higher than 90%, it is determined that there is self-talk voice in the voice data, that is, there is self-talk voice. If the similarity is lower than 90%, it is determined that there is no self-talk voice in the voice data, that is, there is no self-talk voice. In other examples, the similarity between the extracted X-vector and the user's X-vector may also be determined by calculating a Mahalanobis distance or a cosine of an angle between the two, so as to verify whether there is self-talk voice in the voice data.

In this example, by determining the similarity between the extracted voiceprint feature and the user's standard voiceprint feature, whether the voice data collected by the microphone is from the user can be accurately determined, and then whether there is self-talk voice is determined.

In order to provide a clearer explanation of the method for processing voice data according to the present application, a specific example will be described below. The specific example includes the following content:

### I. Self-Talk Voiceprint Registration:

Step 1: Acquire user's voice sample data.

Step 2: Pre-process the voice sample data.

Step 3: Extract audio feature data from the pre-processed voice sample data.

Step 4: Train a pre-built deep neural network based on the audio feature data.

Step 5: Extract a voiceprint feature from the trained deep neural network, determine the extracted voiceprint feature as a user's standard voiceprint feature, and store the user's standard voiceprint feature in a database.

Specifically, the user may take down the first hearing aid from the left ear and hold the first hearing aid near his mouth. At this point, the microphone array in the first hearing aid (e.g., the first microphone array) may be understood as a close-talk microphone array. The user records voice data of a specified text (e.g., self-talk voice) through the close-talk microphone array and the second hearing aid to obtain user's voice sample data, where the second hearing aid is still worn on the left ear. In order to obtain purer self-talk voice, the received voice sample data may be processed by framing, windowing, extracting a differential microphone array, constructing an adaptive blocking matrix, or cancelling interference signals and noise signals through an adaptive interference canceller. The specific process is referenced to the foregoing examples and will not be repeated here.

After the pure self-talk voice is obtained through the pre-processing, a Mel frequency cepstral coefficients (MFCC) feature may be extracted from the pure self-talk voice through an MFCC feature extraction method or other suitable feature extraction methods, and the extracted MFCC feature is normalized. Then, the normalized MFCC feature is input into the pre-built TDNN network. The TDNN network includes an input layer, a plurality of hidden layers, and an output layer. The neural network is trained through the voiceprint feature sample data to obtain a trained TDNN network. Next, the input MFCC feature may be propagated forward by using the trained TDNN network, an X-vector is extracted from the network layers of the network, and the extracted X-vector is determined as a user's standard voiceprint feature and stored in the database.

### II. Self-Talk Voiceprint Detection and Verification:

In user's daily use of hearing aids, the first hearing aid and the second hearing aid in the binaural hearing aid continuously collect voice data through built-in microphones, and send the collected voice data to the processor of the binaural hearing aid, where the voice data includes environmental noise and human voice signals. Upon receiving the voice data, the processor determines first relative delay duration between two microphones in the same microphone array and second relative delay duration between two microphones in different microphone arrays, and then determines the first relative delay duration and the second relative delay duration based on preset self-talk sound determination conditions, to determine whether there is potential self-talk voice in the voice data.

If it is determined that there is potential self-talk voice in the voice data, a self-talk voiceprint verification process will be performed. Specifically, the voice data is also pre-processed first in the same way as the self-talk voiceprint registration process. An X-vector is extracted from the pre-processed voice data by using the same feature extraction method as self-talk voiceprint registration. Then, the similarity between the extracted X-vector and the user's X-vector is determined by calculating a Euclidean distance between the two. If the similarity is higher than 90%, it is determined that there is self-talk voice in the voice data, that is, there is self-talk voice. If the similarity is lower than 90%, it is determined that there is no self-talk voice in the voice data, that is, there is no self-talk voice.

### III. Self-Talk Voice Optimization:

If it is determined that there is self-talk voice in the voice data, the voice data will be enhanced, including reducing the low-frequency gain and adjusting the volume, so as to allow the user to hear clearer self-talk voice.

It should be understood that, although the steps in the flowcharts of the examples as described above are displayed sequentially according to the instructions of arrows, these steps are not necessarily performed sequentially according to the sequence instructed by the arrows. Unless otherwise explicitly specified herein, these steps are not limited in a strict sequence, but may be performed in other sequences. Moreover, at least some of the steps in the flowchart of each example may include a plurality of steps or a plurality of stages. These steps or stages are not necessarily performed at the same time, but may be performed at different time. The steps or stages are not necessarily sequentially performed, but may be performed alternately with other steps or at least some of steps or stages of other steps.

Based on the same inventive concept, an example of the present application further provides an apparatus for processing voice data for implementing the foregoing method for processing voice data. The implementation solution provided by the apparatus to solve the problems is similar to the implementation solution described in the foregoing method. Therefore, the specific limitations in one or more examples of the apparatus for processing voice data provided below may be referenced to the limitations in the method for processing voice data, and will not be repeated here.

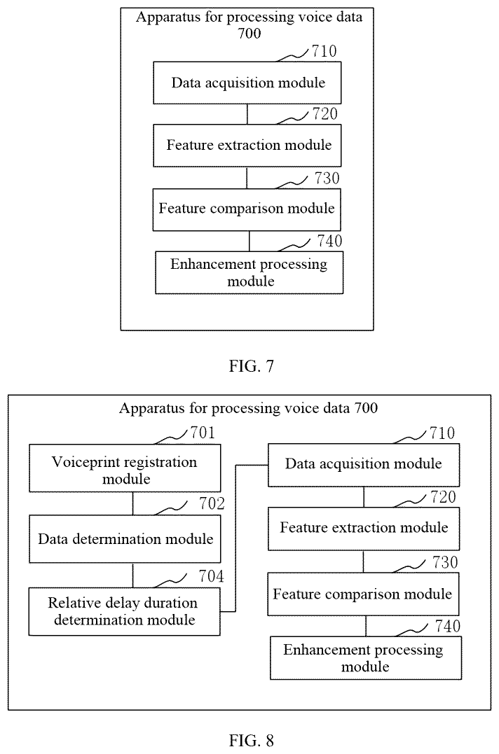

In an example, as shown in FIG. 7, an apparatus for processing voice data 700 is provided, applied to a binaural hearing aid, the binaural hearing aid including a first hearing aid and a second hearing aid, and the apparatus including: a data acquisition module 710, a feature extraction module 720, a feature comparison module 730, and an enhancement processing module 740.

The data acquisition module 710 is configured to acquire voice data collected by the first hearing aid and the second hearing aid respectively.

The feature extraction module 720 is configured to extract a voiceprint feature from the voice data when determining that there is potential self-talk voice in the voice data.

The feature comparison module 730 is configured to compare the voiceprint feature with a stored user's standard voiceprint feature to obtain a comparison result, where the standard voiceprint feature is obtained by processing user's voice sample data, the voice sample data includes close-talk voice data, and the close-talk voice data is collected by the first hearing aid close to the user's mouth.

The enhancement processing module 740 is configured to enhance the voice data if the comparison result indicates that there is self-talk voice in the voice data.

As shown in FIG. 8, in an example, the apparatus further includes a data determination module 702, configured to acquire voice data collected by a first microphone array and a second microphone array respectively, determine relative delay duration between two microphones in the first microphone array and the second microphone array based on the voice data collected by the first microphone array and the second microphone array, and determine, based on the relative delay duration between the two microphones in the first microphone array and the second microphone array, whether there is potential self-talk voice in the voice data.

In an example, the relative delay duration between the two microphones in the first microphone array and the second microphone array includes first relative delay duration between two microphones in the same microphone array and second relative delay duration between two microphones in different microphone arrays. As shown in FIG. 7, the data determination module 702 is further configured to determine an absolute value of a delay difference between the first relative delay duration and a preset relative delay duration reference value, where the relative delay duration reference value is relative delay duration between second microphone arrays in the second hearing aid worn by the user; and determine that there is potential self-talk voice in the voice data when the absolute value of the delay difference is less than a preset relative delay duration error and the second relative delay duration satisfies a preset relative delay duration error range.

In an example, the apparatus further includes a voiceprint registration module 701, configured to acquire user's voice sample data, pre-process the voice sample data, extract audio feature data from the pre-processed voice sample data, train a pre-built deep neural network based on the audio feature data, extract a voiceprint feature from the trained deep neural network, and determine the extracted voiceprint feature as the user's standard voiceprint feature.

In an example, the voiceprint registration module 701 is further configured to acquire user's self-talk voice data collected by the first hearing aid and the second hearing aid, and determine the self-talk voice data as the voice sample data. The first hearing aid may be a hearing aid held close to the user's mouth (e.g., the first hearing aid is positioned closer to the user's mouth than the second hearing aid), and the second hearing aid is a worn hearing aid (e.g., worn on an ear of the user).

In an example, the voiceprint registration module 701 is further configured to construct an adaptive blocking matrix based on the voice sample data, filter input signals of the microphone arrays through the adaptive blocking matrix, and cancel interference voice and noise signals from output signals of the microphone arrays through a preset adaptive interference canceller.

In an example, the voiceprint registration module 701 is further configured to acquire voice activity detection information of the first microphone array, determine a signal-to-noise ratio of the voice data collected by the second microphone array of the second hearing aid, and update parameters of the adaptive blocking matrix and the adaptive interference canceller if the voice activity detection information indicates that a voice activity is detected out and the signal-to-noise ratio is higher than a preset signal-to-noise ratio threshold.

As shown in FIG. 8, in an example, the apparatus further includes a relative delay duration determination module 704, configured to determine a relative impulse response of each microphone in the second hearing aid to the user's mouth, and obtain the relative delay duration reference value based on the relative delay duration between the relative impulse responses.

In an example, the feature comparison module 730 is further configured to determine a similarity between the voiceprint feature and the stored user's standard voiceprint feature, and determine that there is self-talk voice in the voice data when the similarity is higher than a preset similarity threshold.

The various modules in the foregoing apparatus for processing voice data may be fully or partially implemented through software, hardware, or a combination thereof. The foregoing modules may be embedded in or independent of a processor in a computer device in a form of hardware, or stored in a memory of a computer device in a form of software, whereby the processor calls the modules to perform operations corresponding to the modules.

In an example, a binaural hearing aid is provided, including a first hearing aid, a second hearing aid, and a processor, where the processor is connected to the first hearing aid and the second hearing aid. A first microphone array in the first hearing aid and a second microphone array in the second hearing aid collect voice data and send the collected voice data to the processor, and the processor performs the steps of the method for processing voice data in any of the foregoing examples to optimize self-talk voice in the voice data and improve user's listening experience.

It may be understood that the devices listed in the binaural hearing aid are merely devices related to the present application and do not constitute limitations on the binaural hearing aid to which the present application is applied. In addition to the components listed above, the binaural hearing aid may further include a power module, a speaker, and other components.

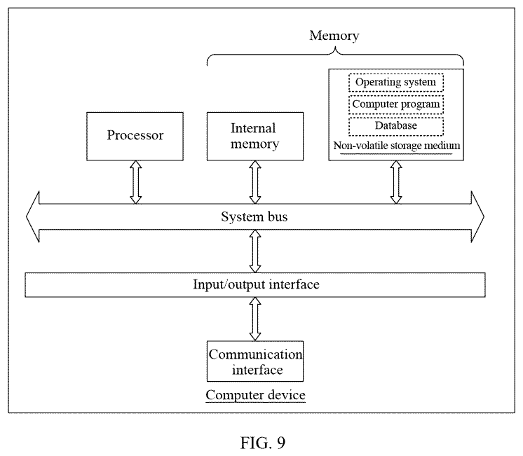

In an example, a computer device is provided. The computer device may be a server, and its internal structure may be as shown in FIG. 9. The computer device includes a processor, a memory, an input/output (I/O) interface, and a communication interface. The processor, the memory, and the input/output interface are connected by a system bus, and the communication interface is connected to the system bus by the input/output interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for running of the operating system and the computer program in the non-volatile storage medium. The database of the computer device is configured to store data such as user's standard voiceprint features and relative delay duration errors. The input/output interface of the computer device is configured to exchange information between the processor and an external device. The communication interface of the computer device is configured to communicate with an external terminal through network connection. The computer program is executed by the processor to implement a method for processing voice data.

A person skilled in the art may understand that the structure shown in FIG. 9 is merely a block diagram of a partial structure related to the solution of the present application, and does not constitute a limitation on the computer device to which the solution of the present application is applied. The specific computer device may include more or fewer parts than shown in the figure, or combine some parts, or have a different arrangement of parts.

In an example, a computer device is provided, including a memory and a processor, the memory storing a computer program, and the processor, when executing the computer program, implementing the steps of the method for processing voice data in any of the foregoing examples.

In one example, a computer-readable storage medium is provided, storing a computer program therein, the computer program, when executed by a processor, implementing the steps of the method for processing voice data in any of the foregoing examples.

In one example, a computer program product is provided, including a computer program, the computer program, when executed by a processor, implementing the steps of the method for processing voice data in any of the foregoing examples.

It should be noted that the user information (including but not limited to user device information, user's voice sample data, user personal information, etc.) and data (including but not limited to data used for analysis such as voice data, stored data such as standard voiceprint features, displayed data, etc.) involved in the present application are all authorized by the user or fully authorized by all parties, and the collection, use, and processing of relevant data comply with relevant regulations.

A person of ordinary skill in the art may understand that all or some of the processes in the methods of the foregoing examples may be implemented by a computer program instructing relevant hardware. The computer program may be stored in a non-volatile computer-readable storage medium. The computer program, when executed, may include the processes of the examples of the above methods. Any reference to the memory, database, or other media used in each example provided by the present application may include at least one of a non-volatile memory and a volatile memory. The non-volatile memory may be a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may be a random access memory (RAM), an external cache, or the like. As an illustration and not a limitation, the RAM may be in various forms, such as a static random access memory (SRAM) or a dynamic random access memory (DRAM). The database involved in each example provided by the present application may include at least one of a relational database and a non-relational database. The non-relational database may include, but is not limited to, a blockchain-based distributed database and the like, without limitation herein. The processor involved in the various examples provided in the present application may be a general-purpose processor, a central processing unit, a graphics processing unit, a digital signal processor, a programmable logic device, a quantum computing-based data processing logic device, an artificial intelligence (AI) processor, etc., without limitation herein.

The technical features of the above examples may be combined in any way. To make the description concise, not all possible combinations of the technical features in the foregoing examples are described. However, as long as there is no contradiction in the combinations of these technical features, these combinations fall within the scope of the present application.

The foregoing examples show merely several implementations of the present application and are described in detail, which, however, are not to be construed as a limitation to the patent scope of the present application. It should be noted that a person of ordinary skill in the art may make variations and improvements without departing from the concept of the present application, and these variations and improvements all fall into the scope of protection of the present application. Therefore, the scope of protection of the present application should be subject to the appended claims.

What is claimed is:

1. A method for processing voice data for a binaural hearing aid comprising a first hearing aid and a second hearing aid, and the method comprising:
acquiring voice data collected by the first hearing aid and the second hearing aid respectively;
extracting a voiceprint feature from the voice data based on determining that potential self-talk voice is in the voice data;
determining, based on voice sample data of a user, standard voiceprint feature associated with the user, wherein the voice sample data comprises close-talk voice data collected by the first hearing aid that is closer to a mouth of the user than the second hearing aid;
comparing the voiceprint feature with the standard voiceprint feature to obtain a comparison result; and
enhancing the voice data based on determining that the comparison result indicates self-talk voice in the voice data.

2. The method according to claim 1, wherein the first hearing aid comprises a first microphone array, the second hearing aid comprises a second microphone array, and the method further comprises:
acquiring the voice data collected by the first microphone array and the second microphone array respectively;
determining a relative delay duration based on the voice data collected by the first microphone array and the second microphone array; and
determining, based on the relative delay duration, whether the potential self-talk voice is in the voice data.

3. The method according to claim 2, wherein the relative delay duration comprises a first relative delay duration between two microphones in the first microphone array and a second relative delay duration between two microphones in the second microphone array; the determining whether the potential self-talk voice is in the voice data comprises:
determining an absolute value of a delay difference between the first relative delay duration and a preset relative delay duration reference value, wherein the relative delay duration reference value is a relative delay duration between two microphones in the second microphone array, and the second hearing aid is a worn hearing aid; and
determining that the potential self-talk voice is in the voice data based on that the absolute value of the delay difference is less than a preset relative delay duration error and the second relative delay duration satisfies a preset relative delay duration error range.

4. The method according to claim 3, wherein before the determining the absolute value of the delay difference, the method further comprises:
determining a relative impulse response of each microphone in the second hearing aid to a mouth of the user; and
obtaining the relative delay duration reference value based on the relative delay duration between the relative impulse responses.

5. The method according to claim 1, wherein before the comparing the voiceprint feature with the standard voiceprint feature, the method further comprises:
acquiring the voice sample data;
processing the voice sample data;
extracting audio feature data from the processed voice sample data;
training a deep neural network based on the audio feature data; and
extracting the voiceprint feature from the trained deep neural network, and determining the extracted voiceprint feature as the standard voiceprint feature.

6. The method according to claim 5, wherein the acquiring the voice sample data comprises:
acquiring self-talk voice data of the user collected by the first hearing aid and the second hearing aid;
determining the self-talk voice data as the voice sample data; and
wherein the first hearing aid is held close to a mouth of the user, and the second hearing aid is a worn hearing aid.

7. The method according to claim 6, wherein the processing the voice sample data comprises:
constructing an adaptive blocking matrix based on the voice sample data, and filtering input signals of microphone arrays in the first hearing aid and the second hearing aid through the adaptive blocking matrix; and
cancelling interference voice and noise signals from output signals of the microphone arrays through a preset adaptive interference canceller.

8. The method according to claim 7, further comprising:
acquiring voice activity detection information of a first microphone array in the first hearing aid;
determining a signal-to-noise ratio of the voice data collected by a second microphone array of the second hearing aid; and
updating parameters of the adaptive blocking matrix and the preset adaptive interference canceller based on determining that the voice activity detection information indicates that a voice activity is detected and the signal-to-noise ratio is higher than a preset signal-to-noise ratio threshold.

9. The method according to claim 1, wherein the comparing the voiceprint feature with the standard voiceprint feature comprises:
determining a similarity between the voiceprint feature and the standard voiceprint feature; and
determining that the voice data comprises the self-talk voice based on that the similarity is higher than a preset similarity threshold.

10. A binaural hearing aid, comprising a first hearing aid, a second hearing aid, and one or more processors connected to the first hearing aid and the second hearing aid respectively, wherein the one or more processors are configured to:
acquire voice data collected by the first hearing aid and the second hearing aid respectively;
extract a voiceprint feature from the voice data based on determining that potential self-talk voice is in the voice data;
determine, based on voice sample data of a user, standard voiceprint feature associated with the user, wherein the voice sample data comprises close-talk voice data collected by the first hearing aid that is closer to a mouth of the user than the second hearing aid;
compare the voiceprint feature with the standard voiceprint feature to obtain a comparison result; and
enhance the voice data based on determining that the comparison result indicates self-talk voice in the voice data.

11. The binaural hearing aid according to claim 10, wherein the first hearing aid comprises a first microphone array, the second hearing aid comprises a second microphone array, and the one or more processors are further configured to:
acquire the voice data collected by the first microphone array and the second microphone array respectively;
determine a relative delay duration based on the voice data collected by the first microphone array and the second microphone array; and
determine, based on the relative delay duration, whether the potential self-talk voice is in the voice data.

12. The binaural hearing aid according to claim 11, wherein the relative delay duration comprises a first relative delay duration between two microphones in the first microphone array and a second relative delay duration between two microphones in the second microphone array, and the one or more processors are further configured to determine whether the potential self-talk voice is in the voice data by:
determining an absolute value of a delay difference between the first relative delay duration and a preset relative delay duration reference value, wherein the relative delay duration reference value is a relative delay duration between two microphones in the second microphone array, and the second hearing aid is a worn hearing aid; and
determining that the potential self-talk voice is in the voice data based on that the absolute value of the delay difference is less than a preset relative delay duration error and the second relative delay duration satisfies a preset relative delay duration error range.

13. The binaural hearing aid according to claim 12, wherein before determining the absolute value of the delay difference, the one or more processors are further configured to:
determine a relative impulse response of each microphone in the second microphone array; and
obtain the relative delay duration reference value based on the relative delay duration between the relative impulse responses.

14. The binaural hearing aid according to claim 10, wherein before comparing the voiceprint feature with the standard voiceprint feature, the one or more processors are further configured to:
acquire the voice sample data;
process the voice sample data;
extract audio feature data from the processed voice sample data;
train a deep neural network based on the audio feature data; and
extract the voiceprint feature from the trained deep neural network, and determining the extracted voiceprint feature as the standard voiceprint feature.

15. The binaural hearing aid according to claim 14, wherein the one or more processors are configured to acquire the voice sample data by:
acquiring self-talk voice data of the user collected by the first hearing aid and the second hearing aid;
determining the self-talk voice data as the voice sample data; and
wherein the first hearing aid is held close to a mouth of the user, and the second hearing aid is a worn hearing aid.

16. The binaural hearing aid according to claim 15, wherein the one or more processors are configured to process the voice sample data by:
constructing an adaptive blocking matrix based on the voice sample data, and filtering input signals of microphone arrays in the first hearing aid and the second hearing aid through the adaptive blocking matrix; and
cancelling interference voice and noise signals from output signals of the microphone arrays through a preset adaptive interference canceller.

17. The binaural hearing aid according to claim 16, wherein the one or more processors are configured to:
acquiring voice activity detection information of a first microphone array in the first hearing aid;
determining a signal-to-noise ratio of the voice data collected by a second microphone array of the second hearing aid; and
updating parameters of the adaptive blocking matrix and the preset adaptive interference canceller based on determining that the voice activity detection information indicates that a voice activity is detected and the signal-to-noise ratio is higher than a preset signal-to-noise ratio threshold.

18. The binaural hearing aid according to claim 10, wherein the one or more processors are configured to compare the voiceprint feature with the standard voiceprint feature by:
determining a similarity between the voiceprint feature and the standard voiceprint feature; and
determining that the voice data comprises the self-talk voice based on that the similarity is higher than a preset similarity threshold.

19. A non-transitory computer-readable medium storing instructions that, when executed, cause a binaural hearing aid to:
acquire voice data collected by a first hearing aid and a second hearing aid of the binaural hearing aid respectively;
extract a voiceprint feature from the voice data based on determining that potential self-talk voice is in the voice data;
determine, based on voice sample data of a user, standard voiceprint feature associated with the user, wherein the voice sample data comprises close-talk voice data collected by the first hearing aid that is closer to a mouth of the user than the second hearing aid;
compare the voiceprint feature with the standard voiceprint feature to obtain a comparison result; and
enhance the voice data based on determining that the comparison result indicates self-talk voice in the voice data.

20. The non-transitory computer-readable medium according to claim 19, wherein the instructions, when executed, cause the binaural hearing aid to enhance the voice data by adjusting a volume of the voice data or adjusting a frequency of the voice data.
